(19) United States
(12) Patent Application Publication
(10) Pub. No.: US 2026/0277921 A1
(43) Pub. Date: Sep. 17, 2026

(54) MANAGEMENT OF PROBLEMATIC DATA BASED ON SKETCH ALGORITHMS AND VECTOR EMBEDDING MODELS

(71) Applicant: Rubrik, Inc., Palo Alto, CA (US)

(72) Inventors: Oran Avraham, Tel Aviv (IL); Ori Lahav, Jerusalem (IL); Ran Pollak, Jerusalem (IL); Aviv Ghilai, Tel Aviv (IL)

(21) Appl. No.: 19/081,895

(22) Filed: Mar. 17, 2025

(51) Int. Cl. G06F 16/2458; G06F 16/22

(52) U.S. Cl. CPC G06F 16/2465; G06F 16/2237

(57) ABSTRACT

Methods, systems, and non-transitory computer readable media are configured to perform operations comprising: causing, by a computing system, a search of a vector database storing vectors associated with items of data; based on the search, determining, by the computing system, a cluster of vectors associated with similar items of data; and determining, by the computing system, a type of problematic data associated with the similar items of data.

### FIELD OF THE INVENTION

The present technology relates to the field of data management. More particularly, the present technology relates to generation of data correlations based on sketch algorithms and embedding models to identify problematic data.

### BACKGROUND

Data of an organization can be dynamic. Data can originate in one of myriad locations in an enterprise, such as a file, a database, or other type of computing resource. From there, data can move across various environments, such as servers, virtual machines, business applications, storage solutions on premises and in the cloud, and the like. In addition, data can be subject to various operations, such as copying, modification, transfer, processing, protection, etc.

### SUMMARY

Various embodiments of the present technology can include systems, methods, and non-transitory computer readable media configured to perform operations comprising: causing, by a computing system, a search of a vector database storing vectors associated with items of data; based on the search, determining, by the computing system, a cluster of vectors associated with similar items of data; and determining, by the computing system, a type of problematic data associated with the similar items of data.

In some embodiments, the type of problematic data is associated with at least one of redundant data, obsolete data, trivial data, misplaced data, or over-permissive data.

In some embodiments, the systems, methods, and non-transitory computer readable media are configured to perform further operations comprising converting a piece of data associated with structured data or semi-structured data into a tabular structure; based on a sketch algorithm, generating a vector associated with the piece of data; and providing the vector associated with the piece of data to the vector database for storage.

In some embodiments, the generating the vector associated with the piece of data is further based on a selection of rows, cells, or columns of the tabular structure as elements for the sketch algorithm.

In some embodiments, the systems, methods, and non-transitory computer readable media are configured to perform further operations comprising: based on a second selection of rows, cells, or columns of the tabular structure as elements for the sketch algorithm, generating a second vector associated with the piece of data; and providing the second vector associated with the piece of data to the vector database for storage.

In some embodiments, the systems, methods, and non-transitory computer readable media are configured to perform further operations comprising: based on a sketch algorithm or a vector embedding model, generating a vector of a piece of data associated with unstructured data; and providing the vector associated with the item of data to the vector database for storage.

In some embodiments, the determining the cluster of vectors associated with the similar items of data is based on a similarity metric.

In some embodiments, metadata associated the similar items of data comprises at least one of creation date, owner, location, size, sensitivity, and permission set, and the type of problematic data associated with the similar items of data is determined based at least in part on the metadata.

In some embodiments, the systems, methods, and non-transitory computer readable media are configured to perform further operations comprising: constructing a data lineage map associated with the similar items of data.

In some embodiments, the systems, methods, and non-transitory computer readable media are configured to perform further operations comprising: providing a notification to an entity associated with the similar items of data for remediation of the type of problematic data.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates a conventional scenario relating to data that can arise in an organization.

FIG. 2 illustrates an example functional block diagram relating to a data management system for generating vectors from data, according to an embodiment of the present technology.

FIG. 3 illustrates a functional block diagram relating to the data management system for determination of problematic data, according to an embodiment of the present technology.

FIG. 4 illustrates an example first screen providing information regarding problematic data, according to an embodiment of the present technology.

FIG. 5 illustrates an example second screen providing information regarding problematic data, according to an embodiment of the present technology.

FIG. 6 illustrates a method, according to an embodiment of the present technology.

FIG. 7 illustrates an example of a computing environment in which a data management system can be implemented, according to an embodiment of the present technology.

FIG. 8 illustrates an example computer system, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Data of an organization can be dynamic. Data can originate in one of myriad locations in an enterprise, such as a file, a database, or other type of computing resource. From there, data can move across various environments, such as servers, virtual machines, business applications, storage solutions on premises and in the cloud, and the like. In addition, data can be subject to various operations, such as copying, modification, transfer, processing, protection, etc.

A comprehensive view of data from an original state to its current state, such as through data lineage, can be challenging to construct. Such a comprehensive view can include how data is processed, transformed, moved, and utilized in an organization. An organization often can employ a wide array of computing systems and platforms, hindering accurate tracking of data across different technologies and computing environments. Large volumes of data can be difficult to properly evaluate without significant computational resources. In addition, a multitude of possible data types within a volume of data, such as structured data, semi-structured data, and unstructured data, can require different analytical strategies. Continuous changes to data or data processes across an organization can pose further complications. These and other challenges can preclude the generation of a comprehensive view of data across an organization.

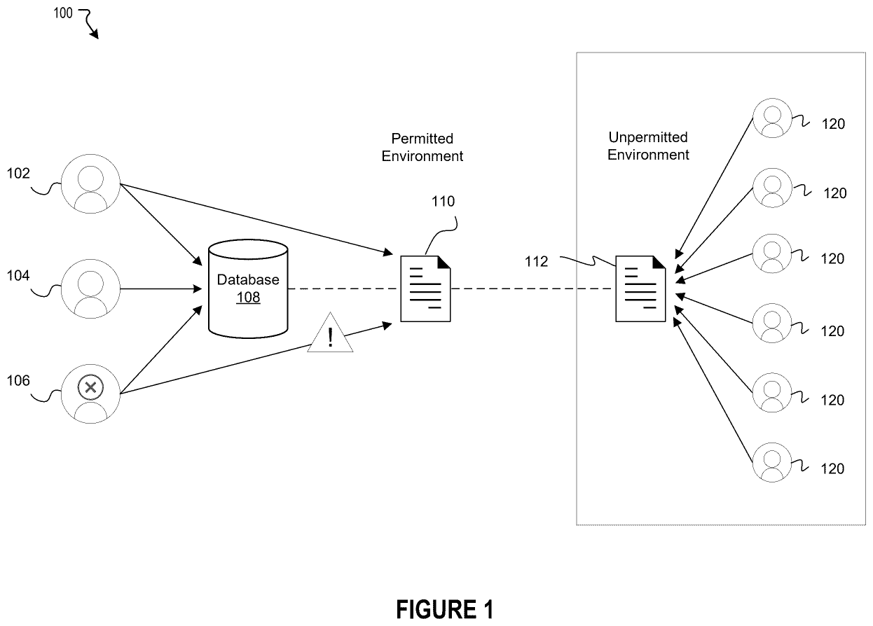

FIG. 1 illustrates a conventional scenario 100 relating to data that can arise in an organization. Various types of users can be associated with the organization. As shown, a user 102, a user 104, and a user 106 are associated with the organization. For example, the users can be employees, contractors, vendors, or partners of the organization. The organization can maintain, access, or otherwise utilize any number of various types of computing systems, including hardware computing resources and software computing resources that can be accessed on premises or in the cloud. The user 102, the user 104, and the user 106 initially have authorized access to a database 108 associated with the organization. The database 108 includes various types of data maintained by the organization.

A file 110 is generated from the database 108. The file 110 can be generated from the database 108 through a variety of actions, such as a dump of the database 108, creation of a backup of the database 108, migration of data from the database 108 to a different computing resource, or the like. Based on their authorized access to the database 108, the user 102, the user 104, and the user 106 initially have authorized access to the file 110. After a time, it is determined that an account associated with the user 106 has been compromised. The account associated with the user 106 can have been compromised through a variety of possible events. As just one example, the account associated with the user 106 can have been compromised through a cyberattack or a network attack on the organization. As a result of the compromised account, the organization immediately terminates the access rights of the user 106 to the database 108. However, access by the user 106 to the file 110 undesirably continues.

The file 110 is located in a permitted environment associated with the organization. For example, the permitted environment can be a production environment through which services of the organization are provided to a customer of the organization. Access to data in the permitted environment is limited to a first set of users. Since the file 110 is in the permitted environment, access rights to the file 110 can be limited to the first set of users. For example, the first set of users can be a relatively small number of persons. Based on sensitive data contained in the file 110, the file 110 should remain in the permitted environment. Notwithstanding, a copy 112 of the file 110 is later generated in or moved to an unpermitted environment. For example, the unpermitted environment can be a development (or temporary) environment through which computing resources are developed for later utilization by customers of the organization. The location of the copy 112 in the unpermitted environment can result from innocent but unauthorized copying of the file 110 or knowingly unauthorized transfer of the file 110 into the unpermitted environment. Access to data in the unpermitted environment can be unlimited or limited to a second set of users 120 that is larger than the first set of users. Thus, access rights to the copy 112 can be unlimited or limited to the second set of users 120. Accordingly, sensitive data in the copy 112 is now undesirably exposed to more users than are authorized. The data management issues arising in the scenario 100 can be challenging for conventional techniques to identify and resolve.

An improved approach rooted in computer technology overcomes the foregoing and other disadvantages associated with conventional approaches specifically arising in the realm of computer technology. The present technology can correlate all data within a system using sketch algorithms, vector embedding models, or similarity hashing algorithms. Data can include files, databases, snapshots, and the like maintained by an organization across any number or variety of computing resources. The sketch algorithms or vector embedding models can generate vectors as representations of the data. The vectors can be generated and analyzed to find similarities or identity across any number of items of data in a vector space. Clustering algorithms can be applied to the vector space to identify duplicated data, misplaced data, and over-permissive data, and to optimize generation of data lineage accounting for such data. These and other inventive features and related advantages of the various embodiments of the present technology are discussed in more detail herein. While sketch algorithms are sometimes referenced herein as examples, the present technology also can utilize vector embedding models and similarity hashing algorithms, as applicable.

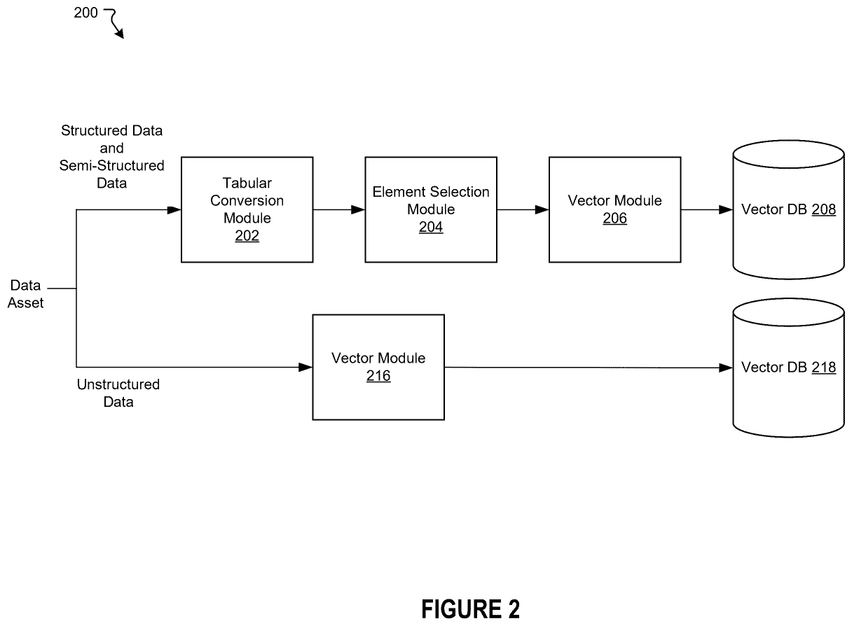

FIG. 2 illustrates an example functional block diagram 200 relating to a data management system for generating vectors from data, according to an embodiment of the present technology. The data management system can identify problematic data among data located across computing resources of an organization and optimize generation of data lineage for the data. The problematic data can be determined based on data correlations reflected by clusters of vectors representative of highly similar or identical data. Data can include any types of data, such files, databases, snapshots, backups, and the like. Problematic data can include, for example, redundant data, obsolete data, trivial data, misplaced data, and over-permissive data. Redundant data can refer to data that is duplicative. Obsolete data can refer to data that is not useful or not current. Trivial data can refer to data that has little or no value to an organization. “ROT data” can refer to one or more of redundant data, obsolete data, and trivial data. Misplaced data can refer to data that resides outside of its allowed scope. Over-permissive data can refer to data that is accessible by more users than are allowed. The foregoing are examples of problematic data, and the present technology applies equally to other types of problematic data. The clustering of vectors representative of similar (or identical) data to identify problematic data in accordance with the present technology poses significant advantages in effectiveness and efficiency over conventional techniques involving large scale individual comparisons between two items of data to determine whether they are identical duplicates.

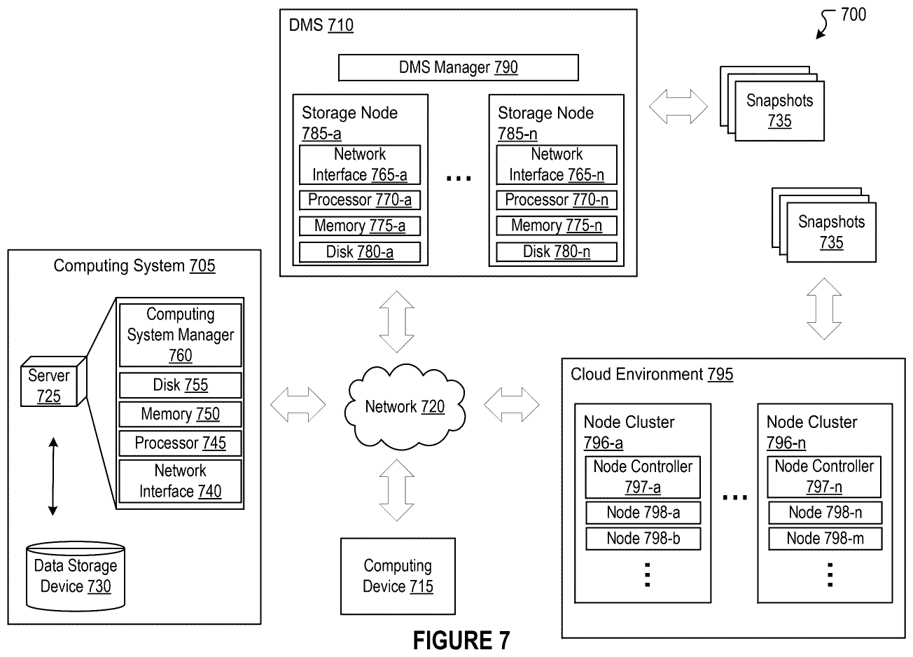

The data management system can be implemented in a variety of computing environments. In some embodiments, the data management system can be implemented or controlled, in whole or in part, in a cloud computing environment associated with an entity in control of a data management service (DMS) 710, as discussed in more detail in connection with FIG. 7. For example, the data management system can be implemented as a service for a customer of the entity in control of the DMS 710. In some embodiments, the data management system can be implemented or controlled by a second entity having a particular type of relationship with the entity in control of the DMS 710, such as a customer of the entity in control of the DMS 710. For instance, the data management system can be implemented, in whole or in part, in a cloud account or an outpost account of the second entity.

In some instances, one entity (e.g., organization) can control, operate, maintain, perform, or provide all of the components and features of the data management system of the present technology, as described herein. In some instances, one entity can control, operate, maintain, perform, or provide some of the components and features of the present technology while one or more other entities can control, operate, maintain, perform, or provide other of the components and features. In some instances, some or all components and features of the present technology can be implemented in a cloud environment. In some instances, some or all components and features of the present technology can be implemented on premises. In some instances, the present technology can be implemented by a server system. In some embodiments, the functionality of the present technology can be distributed between a server system and an application running on a client computing device. Many variations are possible.

The data management system can include a tabular conversion module 202, an element selection module 204, a vector module 206, a vector database 208, a vector module 216, and a vector database 218. The present technology, which can include the components and features (e.g., modules, elements, databases, functionalities, operations, etc.) herein discussed or illustrated in the figures, can have many variations. Different implementations of the present technology may include additional, fewer, integrated, or different components and features. Some components or features may not be shown so as not to obscure relevant details. In various embodiments, one or more of the components and features described herein can be implemented in any suitable combinations.

In the data management system, structured data and semi-structured data can be provided to the tabular conversion module 202. The structured data and semi-structured data can be acquired from, for example, a scan or backup job of data maintained for or otherwise associated with an organization. Structured data can refer to any type of data organized in a fixed format or schema that specifies the structure and types of data. For example, structured data can be or include labels, tags, descriptors, keys, or other types of metadata of a document as well as a corresponding portion (e.g., value, section, etc.) or the entirety of the document associated with the metadata. Examples of structured data can include data maintained by software applications or services, data stored in relational databases, data stored in spreadsheets, and the like. Structured data can be expressed in various types of key-value pairs, such as attribute-value pairs, name-value pairs, field-value pairs, property-value pairs, index-value pairs, and the like. Semi-structured data can refer to data that does not have a fixed schema like structured data. Semi-structured data can contain metadata to describe and distinguish semantic elements from one another. Semi-structured data often can reflect hierarchical organization including nested elements. Examples of semi-structured data can include JSON, Parquet, XML, HTML, and the like.

The tabular conversion module 202 can transform structured data and semi-structured data into a tabular form or structure. Key-value pairs of structured data and semi-structured data can be deconstructed into keys and associated values. The keys can be transformed into columns of one or more tables while the associated values can be transformed as entries in rows under corresponding columns. In this manner, a tabular structure (e.g., a table) containing key-value pairs of structured data or semi-structured data can be generated to represent the structured data or semi-structured data.

The element selection module 204 can select one or more elements of a tabular structure corresponding to an item of structured data or unstructured data. The selected elements can be provided to generate vectors, as discussed in more detail herein. For example, every cell of a tabular structure can be selected as an element to generate a vector. As another example, every column of a tabular structure can be selected as an element to generate a vector. As yet another example, every row of a tabular structure can be selected as an element to generate a vector. In some embodiments, a selected combination of element types (e.g., cells, columns, rows) can be chosen as elements to generate a vector.

In some embodiments, a plurality of element types of a tabular structure corresponding to an item of structured data or semi-structured data can be selected for generation of a corresponding plurality of vectors representative of the item of structured data or semi-structured data. The selection of element types can be configurable based on requirements of a particular implementation. For example, each cell of a tabular structure corresponding to an item of structured data or semi-structured data can be selected as an element for generation of a vector representative of the item of structured data or semi-structured data. As another example, each cell of a tabular structure corresponding to an item of structured data or semi-structured data can be selected as an element for generation of a first vector representative of the item and each column of the tabular structure can be selected as an element for generation of a second vector representative of the item. As yet another example, each cell of a tabular structure corresponding to an item of structured data or semi-structured data can be selected as an element for generation of a first vector representative of the item; each column of the tabular structure can be selected as an element for generation of a second vector representative of the item; and, each row of the tabular structure can be selected as an element for generation of a third vector representative of the item. Many variations are possible.

The vector module 206 can generate one or more vectors based on selected elements of a tabular structure corresponding to an item of structured data or semi-structured data. In some embodiments, the vector module 206 can implement or utilize a sketch algorithm to generate vectors. The sketch algorithm can generate vectors in a vector space whereby vectors representative of relatively similar or identical structured data or semi-structured data are positioned relatively closely to one another while vectors representative of relatively dissimilar structured data or semi-structured data are positioned relatively far from one another. Any suitable type of sketch algorithm for structured data and semi-structured can be utilized. In some embodiments, the sketch algorithm can be, for example, MinHash or HyperLogLog. In some embodiments, when a Jaccard index based on selected elements of tabular structures corresponding to different items of structured data or semi-structured data is relatively high, the sketch algorithm can generate in a vector space vectors representative of the items of structured data or semi-structured data that are relatively close to one another. Likewise, when a Jaccard index based on selected elements of tabular structures corresponding to different items of structured data or semi-structured data is relatively low, the sketch algorithm can generate in the vector space vectors that are relatively far from one another.

The sketch algorithm can generate vectors based on selected elements of tabular structures corresponding to items of structured data or semi-structured data, as discussed. For example, when cells of tabular structures are selected as an element, the sketch algorithm can generate a vector for an item of structured data or semi-structured data based on cells of a tabular structure corresponding to the item of structured data or semi-structured data. As another example, when columns of tabular structures are selected as an element, the sketch algorithm can generate a vector for an item of structured data or semi-structured data based on columns of a tabular structure corresponding to the item of structured data or semi-structured data. As yet another example, when rows of tabular structures are selected as an element, the sketch algorithm can generate a vector for an item of structured data or semi-structured data based on rows of a tabular structure corresponding to the item of structured data or semi-structured data. In other examples, the sketch algorithm can generate vectors based on other types or combinations of selected elements from tabular structures corresponding to structured data or semi-structured data.

The vector module 206 can cause a vector or a plurality of vectors representative of a given item of structured data or semi-structured data to be generated, as discussed. The number of different elements, or combinations thereof, selected by the element selection module 204 from a tabular structure corresponding to a given item of structured data or semi-structured data can determine the number of vectors generated by the vector module 206 for the item. For example, the vector module 206 can generate a vector based on an element (e.g., columns) selected from a tabular structure corresponding to a given item of structured data or semi-structured data. As another example, the vector module 206 can generate a first vector based on a first element (e.g., columns) selected from a tabular structure corresponding to a given item of structured data or semi-structured data and a second vector based on a second element (e.g., rows) selected from the tabular structure. As yet another example, the vector module 206 can generate a first vector based on a first element (e.g., columns) selected from a tabular structure corresponding to a given item of structured data or semi-structured data, a second vector based on a second element (e.g., rows) selected from the tabular structure, and a third vector based on a third element (e.g., cells) selected from the tabular structure. The foregoing are examples and many variations are possible.

The vector module 206 can generate metadata associated with each vector. Metadata associated with a vector can include data indicating the element selected for generation of the vector. For example, when a vector is generated based on selection of cells (or entries) of an associated tabular structure as an element, the vector module 206 can generate metadata associated with the vector that indicates the vector is generated based on cells as the selected element. As another example, when a vector is generated based on selection of columns of an associated tabular structure as an element, the vector module 206 can generate metadata associated with the vector that indicates the vector is generated based on columns as the selected element. In some embodiments, the metadata indicating elements selected for generation of a vector can be stored with the vector.

The vectors generated by the vector module 206 can be stored in the vector database 208. The vector database 208 can be any suitable vector database. The vector database 208 can be or include, for example, Pinecone, Azure AI Search, Milvus, etc. As discussed, a given item of structured data or semi-structured data can be associated with a vector or a plurality of vectors. In some instances, metadata associated with a vector can be maintained with the vector in the database 208. In some instances, metadata associated with a vector can be stored in a database other than the database 208 and, for each vector, the database 208 can maintain a pointer to the associated metadata. Many variations are possible.

In the data management system, unstructured data can be provided to the vector module 216. The unstructured data can be acquired from, for example, a scan or backup of data maintained for or otherwise associated with an organization. Unstructured data can refer to data that is free form or not structured. Unstructured data can be included in documents containing substantial amounts of text without associated metadata. Documents containing unstructured data can include, for example, documents generated from software applications such as Word, Acrobat, Google Docs, etc.

The vector module 216 can generate one or more vectors based on unstructured data. In some embodiments, the vector module 206 can implement or utilize a sketch algorithm to generate vectors. The sketch algorithm can generate vectors in a vector space whereby vectors representative of relatively similar or identical unstructured data are positioned relatively closely to one another while vectors representative of relatively dissimilar unstructured data are positioned relatively far from one another. Any suitable type of sketch algorithm for unstructured data can be utilized. In some embodiments, the sketch algorithm can be, for example, SimHash. In some embodiments, the vector module 216 can implement or utilize an embedding model to generate vectors in an embedding space. Unlike a sketch algorithm, the embedding model can generate embedding vectors in the embedding space based on semantic similarity of unstructured data represented by the embedding vectors. The embedding model can generate embedding vectors in a vector embedding space whereby embedding vectors representative of relatively similar or identical unstructured data in terms of their semantic meaning are positioned relatively closely to one another while embedding vectors representative of relatively dissimilar unstructured data in terms of their semantic meaning are positioned relatively far from one another. Any suitable type of embedding model for unstructured data can be utilized. In some embodiments, the embedding model can be, for example, Sentence-BERT (Bidirectional Encoder Representations from Transformers), BERT, Ada-002, and the like. The vectors generated by the vector module 216 can be stored in the vector database 218. The vector database 218 can be any suitable vector database. The vector database 218 can be or include, for example, Pinecone, Azure AI Search, Milvus, etc.

An item of data (e.g., structured data, semi-structured data, unstructured data) from which a vector is generated can be stored in one or more databases. In some embodiments, an item of data can be stored in a database other than the vector database 208 and the vector database 218. For each vector maintained in the vector database 208 and the vector database 218, the vector database 208 and the vector database 218 can maintain a pointer to storage location of the item of data represented by the vector. In some embodiments, a mapping log can include information that provides the storage location of items of data represented by vectors maintained in the vector database 208 and the vector database 218.

Metadata about items of data from which the vectors are generated can be maintained. Metadata associated with an item of data can include, for example, creation date, owner, location, size, access date, permission set, revision date, sensitivity, and the like. In some embodiments, the metadata can be maintained with associated items of data in the same database. In some embodiments, metadata associated with an item of data can be maintained with a corresponding vector in the vector database 208 and the vector database 218. In some instances, metadata associated with an item of data can be stored in a database other than the vector database 208 and the vector database 218 and, for each vector corresponding to the item of data, the vector database 208 and the vector database 218 can maintain a pointer to the storage location of the associated metadata. Many variations are possible.

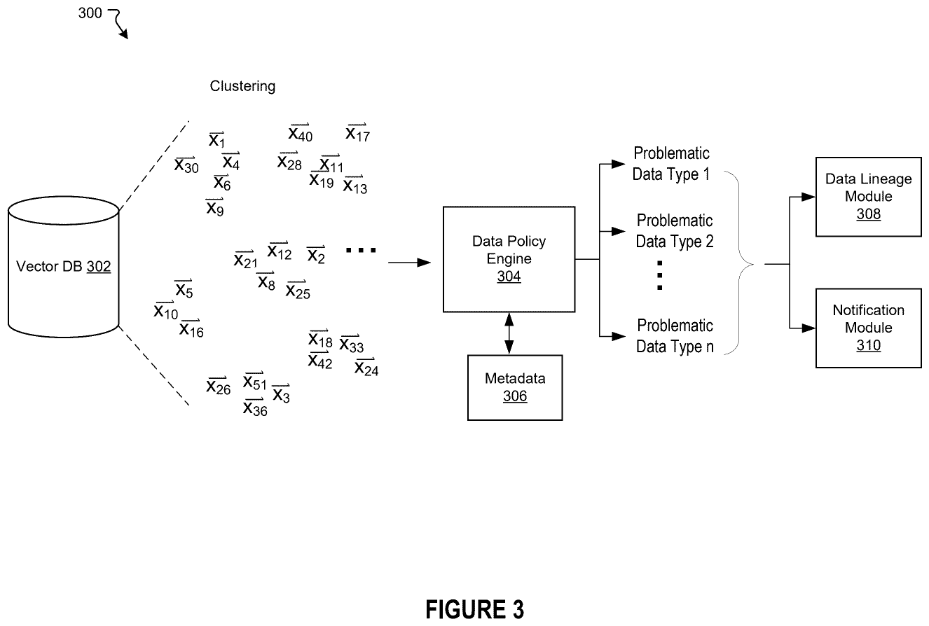

FIG. 3 illustrates a functional block diagram 300 relating to the data management system for determination of problematic data, according to an embodiment of the present technology. The data management system can include a vector database 302, a data policy engine 304, metadata 306, a data lineage module 308, and a notification module 310. The vector database 302 can store vectors. In some embodiments, the vectors stored in the vector database 302 can be generated by the vector module 206 or the vector module 216. In some embodiments, the vector database 302 can be the vector database 208 or the vector database 218. While the vector database 302 is shown for ease of illustration as a single database, the vector database 302 can represent multiple databases. For example, the vector database 302 can represent two databases whereby a first database maintains vectors representative of structured data (and semi-structured data) that were generated by a first sketch algorithm that is suitable for structured data and a second database maintains vectors representative of unstructured data that were generated by a second sketch algorithm or an embedding model that is suitable for unstructured data.

The vector database 302 can be associated with a vector space in which vectors are located. As discussed, in the vector space, vectors representative of relatively similar or identical data (e.g., structured data, semi-structured data, unstructured data) are positioned relatively closely to one another while vectors representative of relatively dissimilar data are positioned relatively far from one another.

The vector database 302 can be queried by a job to cluster the vectors in the vector database 302. Clustering of the vectors can be performed by any suitable clustering technique. The job can specify a definition of similarity to cluster the vectors based on a suitable similarity metric. For example, if the vectors stored in the vector database 302 are generated through MinHash, a similarity metric of L0 norm (zero norm) can be utilized. Different similarity metrics (e.g., L1 norm) for sketch algorithms can be used. As another example, if the vectors stored in the vector database 302 are generated through an embedding model, a similarity metric of L2 norm (Euclidean norm) can be utilized. Other similarity metrics (e.g., cosine distance) for embedding models can be used. In addition, when a plurality of vectors can represent an item of structured data and semi-structured data, the job can specify a type of element (e.g., cells, columns, rows) as a filter on the vectors to be clustered. Clustering of vectors can advantageously allow correlation of highly similar items of data, such as items of data that reflect a small degree (e.g., less than a threshold percentage value) of difference or that exhibit relationships involving a source and subsets thereof. The ability to determine not merely identical but also highly similar items of data through clustering of associated vectors poses significant advantages because problematic data can often arise in contexts involving non-identical data.

The data policy engine 304 can determine different types of problematic data among items of data represented by vectors. The data policy engine 304 can determine high similarity or identity among items of data when vectors representative of the items of data are located in a cluster. The data policy engine 304 can access metadata 306 about the items of data. As discussed, metadata 306 associated with an item of data can include, for example, a creation date of the item of data, an owner of the item of data, a location indicating an environment in which the item of data should be located, a size (e.g., in bytes) of the item of data, a limited set of persons (or roles) permitted to access the item of data, a last access date of the item of data, one or more revision dates of the item of data, and a level of sensitivity (or security) of the item of data. Other types of information can be included in the metadata 306.

Based on determination of high similarity among items of data corresponding to a cluster of vectors and metadata 306 about the items of data, the data policy engine 304 can identify problematic data. In some embodiments, the problematic data can be identified through rules driven techniques. For example, assume vectors in a cluster are similar within a threshold level of difference. If metadata 306 indicates that items of data represented by the vectors have different creation dates, the data policy engine 304 can determine that the items of data are copies of one another. Accordingly, some of the items of data can be determined to be redundant data. As another example, assume a first vector and a second vector are in a cluster. If a first item of data represented by the first vector is associated with metadata 306 indicating a creation date or revision date that is earlier by a threshold amount of time than a creation date or revision date of a second item of data represented by the second vector, the data policy engine 304 can determine that the first item of data is not current in view of the second item of data. Accordingly, the first item of data can be determined to be obsolete data. As yet another example, assume a plurality of vectors are in a cluster. If a first item of data represented by a first vector of the plurality of vectors is associated with metadata 306 indicating a number of access dates that are less than by a threshold value a number of access dates of items of data represented by the other vectors of the plurality of vectors, the data policy engine 304 can determine that the first item of data is not frequently accessed or not valuable. Accordingly, the first item of data can be determined to be trivial data.

As a further example, assume a plurality of vectors are in a cluster. If a first item of data represented by a first vector of the plurality of vectors is associated with metadata 306 indicating a first environment (e.g., a production environment) while items of data represented by the other vectors of the plurality of vectors are associated with metadata 306 indicating a second environment (e.g., a development environment), the data policy engine 304 can determine that the first item of data has been copied to an undesirable or unpermitted environment. Accordingly, the first item of data can be determined to be misplaced data.

As yet a further example, assume a plurality of vectors are in a cluster. Assume further a first item of data represented by a first vector of the plurality of vectors is associated with metadata 306 indicating a first set of users who are permitted to access the first item of data while items of data represented by a threshold number of the other vectors of the plurality of vectors are associated with metadata 306 indicating a second set of users who are permitted to access the items of data. If the second set of users is different from or smaller than the first set of users, the data policy engine 304 can determine that access rights to the first item of data are incorrect and not reflective of a degree of sensitivity or security warranted for the first item of data. Accordingly, the first item of data can be determined to be over-permissive data. The foregoing are merely examples for purposes of illustration. Many other variations are possible.

The data policy engine 304 can implement machine learning techniques to determine different types of problematic data arising from items of data represented by a cluster of vectors. In some embodiments, the data policy engine 304 can utilize a machine learning model, such as a neural network, to identify items of data as problematic. The neural network can be trained with suitable training data. The training data can be associated with different types of problematic data, such as redundant data, obsolete data, trivial data, misplaced data, and over-permissive data. For example, a training example can include features relating to a cluster of vectors. The training example further can include features relating to metadata 360 associated with items of data represented by the vectors in the cluster. The training example further can include a label indicating a vector in the cluster of vectors that constitutes problematic data and a label indicating the type of problematic data. Many other types of training data can be utilized. In some embodiments, the data policy engine 304 can utilize any suitable generative AI model or foundation model, such as a large language model (LLM), to identify problematic data within items of data represented by a cluster of vectors. The identification of problematic data can be performed by the LLM through a suitable prompt. For example, the prompt can include a cluster of vectors and corresponding metadata 306 as well as an instruction to identify a vector associated with problematic data and the type of problematic data. The prompt additionally can include one or more examples (e.g., one-shot prompt, few-shot prompt) in which an item of data represented by a vector in a cluster of vectors has been determined to be problematic data and the type of problematic data has been identified. Many variations are possible.

Based on the identification of problematic data, the data lineage model 308 can optimize generation of data lineage. The identification of problematic data can allow the data lineage model 308 to remove significant volumes of problematic data as noise. The data lineage model 308 then can determine data lineage using the similarity path of each item of data (e.g., file) and the change history for each item of data in its similarity path. The identification and removal of problematic data can provide myriad advantages in generation of data lineage. For example, the identification of problematic data can simplify and streamline lineage tracing because the amount of data can be materially reduced. As another example, identification of problematic data can preserve reliable, accurate data while eliminating sources of lineage tracing error. In addition, identification of problematic data can allow focus on the most important data for lineage tracing efforts.

The notification module 310 can provide information regarding identifications of problematic data. For example, the information can be provided to an entity in control of the data management system or an entity in control of the problematic data. For example, the entity in control of the problematic data can be a customer of the entity in control of the data management system. The information can include, for example, an item of data constituting problematic data and the type of problematic data. In some embodiments, the information can be provided through a computing interface. For example, the entity in control of the data management system can maintain a software application or service through which the information can be presented to the entity in control of the problematic data.

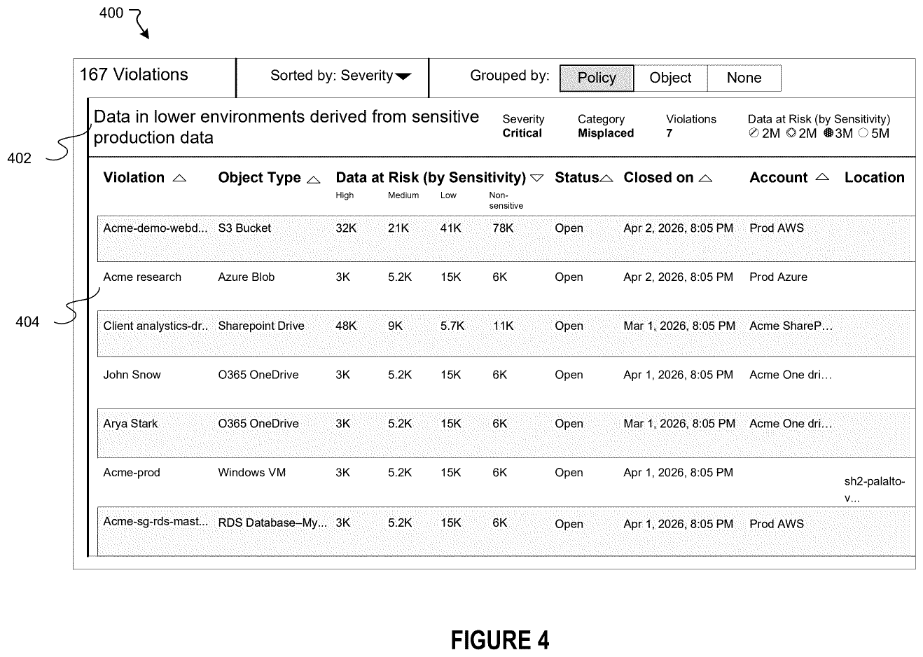

FIG. 4 is an example screen 400 providing information regarding problematic data, according to an embodiment of the present technology. The screen 400 is a simplified illustration of a screen (or page) that can be generated by a software application or service provided by an entity in control of the data management system. The screen 400 includes a policy (e.g., “Data in lower environments derived from sensitive production data”) that has been selected from a plurality of policies. The screen 400 includes a table having a list of violations of the policy that have been determined based on, for example, a scan or backup data of an organization. For example, the organization can be a customer of the entity in control of the data management system. The list of violations of the policy relate to misplaced data determined by the data management system, as discussed herein. The list of violations relate to a selected level of severity (e.g., “Critical”) associated with the violations. As shown, the list of violations includes a violation 404 associated with misplaced data (e.g., “Acme research”). The violation 404 can be selected by an appropriate input provided to the software application or service to cause presentation of additional information regarding the violation 404. In other examples, other screens can provide information about other policies and violations associated with other types of problematic data, such as redundant data, obsolete data, trivial data, and over-permissive data. Many variations are possible.

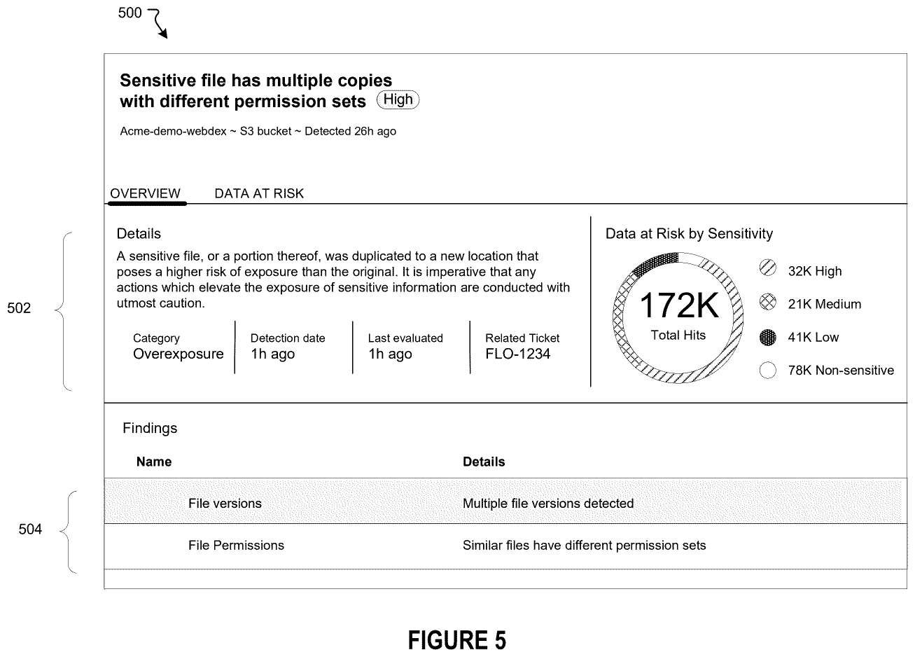

FIG. 5 is an example screen 500 providing information regarding problematic data, according to an embodiment of the present technology. The screen 500 is a simplified illustration of a screen (or page) that can be generated by a software application or service in response to selection of a violation from a list of violations in a screen that is similar to the screen 400. The screen 500 relates to a policy (e.g., “Sensitive file has multiple copies with different permission sets”) and a particular violation of the policy relating to over-permissive data, as determined by the data management system. The screen 500 includes information 502 regarding the violation and the identification of the violation as over-permissive data (e.g., “Overexposure”). The screen further includes information 504 regarding details about the violation of the policy, such as the existence of multiple similar versions of data (e.g., files) and the multiple versions having different permission sets. The provision of such information through the screen 500 can warrant potential remedial action by the entity in control of the over-permissive data. Remedial action can include, for example, removal of data associated with improper permission sets or correction of the improper permission sets. Again, the screen 500 is merely an example. In other examples, information about other policies, other violations, and other types of problematic data can be presented.

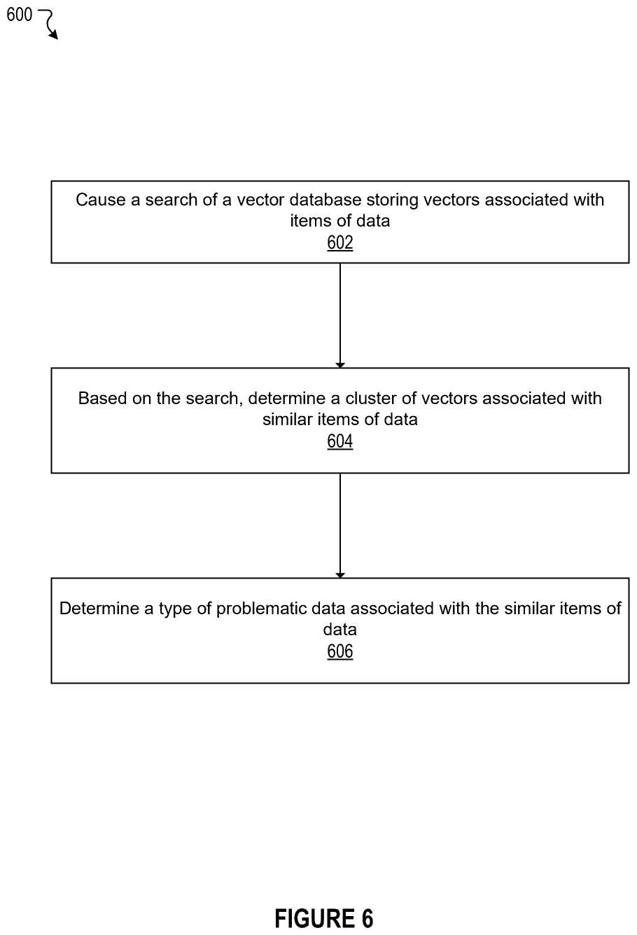

FIG. 6 illustrates an example method, according to an embodiment of the present technology. It should be understood that there can be additional, fewer, or alternative steps performed in similar or alternative orders, or in parallel, based on the various features and embodiments discussed herein unless otherwise stated. At block 602, the method 600 can cause a search of a vector database storing vectors associated with items of data. At block 604, the method 600 can, based on the search, determine a cluster of vectors associated with similar items of data. At block 606, the method 600 can determine a type of problematic data associated with the similar items of data.

FIG. 7 illustrates an example of a computing environment 700 in which a data management system can be implemented in accordance with the present technology. The computing environment 700 may include a computing system 705, a data management service (DMS) 710, and one or more computing devices 715, which may be in communication with one another via a network 720. The computing system 705 may generate, store, process, modify, or otherwise use associated data, and the DMS 710 may provide one or more data management services for the computing system 705. For example, the DMS 710 may provide a data backup service, a data recovery service, a data classification service, a data transfer or replication service, a malware protection service, a sensitive data classification service, and an artificial intelligence (AI) assisted generative data service. For example, the AI assisted generative data service can support chatbot services empowering users of the DMS 710 to ask questions, troubleshoot problems, or initiate workflows.

The network 720 may allow the one or more computing devices 715, the computing system 705, and the DMS 710 to communicate (e.g., exchange information) with one another. The network 720 may include aspects of one or more wired networks (e.g., the Internet), one or more wireless networks (e.g., cellular networks), or any combination thereof. The network 720 may include aspects of one or more public networks or private networks, as well as secured or unsecured networks, or any combination thereof. The network 720 also may include any quantity of communications links and any quantity of hubs, bridges, routers, switches, ports or other physical or logical network components.

A computing device 715 may be used to input information to or receive information from the computing system 705, the DMS 710, or both. For example, a user of the computing device 715 may provide user inputs via the computing device 715, which may result in commands, data, or any combination thereof being communicated via the network 720 to the computing system 705, the DMS 710, or both. Additionally, or alternatively, a computing device 715 may output (e.g., display) data or other information received from the computing system 705, the DMS 710, or both. A user of a computing device 715 may, for example, use the computing device 715 to interact with one or more Uls (e.g., graphical user interfaces (GUIs)) to operate or otherwise interact with the computing system 705, the DMS 710, or both. Though one computing device 715 is shown in FIG. 7, it is to be understood that the computing environment 700 may include any quantity of computing devices 715.

A computing device 715 may be a stationary device (e.g., a desktop computer or access point) or a mobile device (e.g., a laptop computer, tablet computer, or cellular phone). In some examples, a computing device 715 may be a commercial computing device, such as a server or collection of servers. And in some examples, a computing device 715 may be a virtual device (e.g., a virtual machine). Though shown as a separate device in the example computing environment of FIG. 7, it is to be understood that in some cases a computing device 715 may be included in (e.g., may be a component of) the computing system 705 or the DMS 710.

The computing system 705 may include one or more servers 725 and may provide (e.g., to the one or more computing devices 715) local or remote access to applications, databases, or files stored within the computing system 705. The computing system 705 may further include one or more data storage devices 730. Though one server 725 and one data storage device 730 are shown in FIG. 7, it is to be understood that the computing system 705 may include any quantity of servers 725 and any quantity of data storage devices 730, which may be in communication with one another and collectively perform one or more functions ascribed herein to the server 725 and data storage device 730.

A data storage device 730 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 730 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 730 may be a database (e.g., a relational database), and a server 725 may host (e.g., provide a database management system for) the database.

A server 725 may allow a client (e.g., a computing device 715) to download information or files (e.g., executable, text, application, audio, image, or video files) from the computing system 705, to upload such information or files to the computing system 705, or to perform a search related to particular information stored by the computing system 705. In some examples, a server 725 may act as an application server or a file server. In general, a server 725 may refer to one or more hardware devices that act as the host in a client-server relationship or a software process that shares a resource with or performs work for one or more clients.

A server 725 may include a network interface 740, processor 745, memory 750, disk 755, and computing system manager 760. The network interface 740 may enable the server 725 to connect to and exchange information via the network 720 (e.g., using one or more network protocols). The network interface 740 may include one or more wireless network interfaces, one or more wired network interfaces, or any combination thereof. The processor 745 may execute computer-readable instructions stored in the memory 750 in order to cause the server 725 to perform functions ascribed herein to the server 725. The processor 745 may include one or more processing units, such as one or more central processing units (CPUs), one or more graphics processing units (GPUs), or any combination thereof. The memory 750 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 755 may include one or more HDDs, one or more SSDs, or any combination thereof. Memory 750 and disk 755 may comprise hardware storage devices. The computing system manager 760 may manage the computing system 705 or aspects thereof (e.g., based on instructions stored in the memory 750 and executed by the processor 745) to perform functions ascribed herein to the computing system 705. In some examples, the network interface 740, processor 745, memory 750, and disk 755 may be included in a hardware layer of a server 725, and the computing system manager 760 may be included in a software layer of the server 725. In some cases, the computing system manager 760 may be distributed across (e.g., implemented by) multiple servers 725 within the computing system 705.

In some examples, the computing system 705 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 705 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 715 over the network 720). IaaS may refer to a service in which physical computing resources are used to instantiate one or more virtual machines, the resources of which are made available to one or more client devices over a network (e.g., to one or more computing devices 715 over the network 720).

In some examples, the computing system 705 or aspects thereof may implement or be implemented by one or more virtual machines. The one or more virtual machines may run various applications, such as a database server, an application server, or a web server. For example, a server 725 may be used to host (e.g., create, manage) one or more virtual machines, and the computing system manager 760 may manage a virtualized infrastructure within the computing system 705 and perform management operations associated with the virtualized infrastructure. The computing system manager 760 may manage the provisioning of virtual machines running within the virtualized infrastructure and provide an interface to a computing device 715 interacting with the virtualized infrastructure. For example, the computing system manager 760 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 755, the memory, the processor 745, the network interface 740, the data storage device 730, or any combination thereof in support of running the various applications. Storage resources (e.g., the disk 755, the memory 750, or the data storage device 730) that are virtualized may be accessed by applications as a virtual disk.

The DMS 710 may provide one or more data management services for data associated with the computing system 705 and may include DMS manager 790 and any quantity of storage nodes 785. The DMS manager 790 may manage operation of the DMS 710, including the storage nodes 785. Though illustrated as a separate entity within the DMS 710, the DMS manager 790 may in some cases be implemented (e.g., as a software application) by one or more of the storage nodes 785. In some examples, the storage nodes 785 may be included in a hardware layer of the DMS 710, and the DMS manager 790 may be included in a software layer of the DMS 710. In the example illustrated in FIG. 7, the DMS 710 is separate from the computing system 705 but in communication with the computing system 705 via the network 720. It is to be understood, however, that in some examples at least some aspects of the DMS 710 may be located within computing system 705. For example, one or more servers 725, one or more data storage devices 730, and at least some aspects of the DMS 710 may be implemented within the same cloud environment or within the same data center.

Storage nodes 785 of the DMS 710 may include respective network interfaces 765, processors 770, memories 775, and disks 780. The network interfaces 765 may enable the storage nodes 785 to connect to one another, to the network 720, or both. A network interface 765 may include one or more wireless network interfaces, one or more wired network interfaces, or any combination thereof. The processor 770 of a storage node 785 may execute computer-readable instructions stored in the memory 775 of the storage node 785 in order to cause the storage node 785 to perform processes described herein as performed by the storage node 785. A processor 770 may include one or more processing units, such as one or more CPUs, one or more GPUs, or any combination thereof. The memory 775 may comprise one or more types of memory (e.g., RAM, SRAM, DRAM, ROM, EEPROM, Flash, etc.). A disk 780 may include one or more HDDs, one or more SDDs, or any combination thereof. Memories 775 and disks 780 may comprise hardware storage devices. Collectively, the storage nodes 785 may in some cases be referred to as a storage cluster or as a cluster of storage nodes 785.

The DMS 710 may provide a backup and recovery service for the computing system 705. For example, the DMS 710 may manage the extraction and storage of snapshots 735 associated with different point-in-time versions of one or more target computing objects within the computing system 705. A snapshot 735 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 735 may also be used to restore (e.g., recover) the corresponding computing object as of the particular point in time corresponding to the snapshot 735. A computing object of which a snapshot 735 may be generated may be referred to as snappable. Snapshots 735 may be generated at different times (e.g., periodically or on some other scheduled or configured basis) in order to represent the state of the computing system 705 or aspects thereof as of those different times. In some examples, a snapshot 735 may include metadata that defines a state of the computing object as of a particular point in time. For example, a snapshot 735 may include metadata associated with (e.g., that defines a state of) some or all data blocks included in (e.g., stored by or otherwise included in) the computing object. Snapshots 735 (e.g., collectively) may capture changes in the data blocks over time. Snapshots 735 generated for the target computing objects within the computing system 705 may be stored in one or more storage locations (e.g., the disk 755, memory 750, the data storage device 730) of the computing system 705, in the alternative or in addition to being stored within the DMS 710, as described below.

To obtain a snapshot 735 of a target computing object associated with the computing system 705 (e.g., of the entirety of the computing system 705 or some portion thereof, such as one or more databases, virtual machines, or filesystems within the computing system 705), the DMS manager 790 may transmit a snapshot request to the computing system manager 760. In response to the snapshot request, the computing system manager 760 may set the target computing object into a frozen state (e.g., a read-only state). Setting the target computing object into a frozen state may allow a point-in-time snapshot 735 of the target computing object to be stored or transferred.

In some examples, the computing system 705 may generate the snapshot 735 based on the frozen state of the computing object. For example, the computing system 705 may execute an agent of the DMS 710 (e.g., the agent may be software installed at and executed by one or more servers 725), and the agent may cause the computing system 705 to generate the snapshot 735 and transfer the snapshot 735 to the DMS 710 in response to the request from the DMS 710. In some examples, the computing system manager 760 may cause the computing system 705 to transfer, to the DMS 710, data that represents the frozen state of the target computing object, and the DMS 710 may generate a snapshot 735 of the target computing object based on the corresponding data received from the computing system 705.

Once the DMS 710 receives, generates, or otherwise obtains a snapshot 735, the DMS 710 may store the snapshot 735 at one or more of the storage nodes 785. The DMS 710 may store a snapshot 735 at multiple storage nodes 785, for example, for improved reliability. Additionally, or alternatively, snapshots 735 may be stored in some other location connected with the network 720. For example, the DMS 710 may store more recent snapshots 735 at the storage nodes 785, and the DMS 710 may transfer less recent snapshots 735 via the network 720 to a cloud environment (which may include or be separate from the computing system 705) for storage at the cloud environment, a magnetic tape storage device, or another storage system separate from the DMS 710.

Updates made to a target computing object that has been set into a frozen state may be written by the computing system 705 to a separate file (e.g., an update file) or other entity within the computing system 705 while the target computing object is in the frozen state. After the snapshot 735 (or associated data) of the target computing object has been transferred to the DMS 710, the computing system manager 760 may release the target computing object from the frozen state, and any corresponding updates written to the separate file or other entity may be merged into the target computing object.

In response to a restore command (e.g., from a computing device 715 or the computing system 705), the DMS 710 may restore a target version (e.g., corresponding to a particular point in time) of a computing object based on a corresponding snapshot 735 of the computing object. In some examples, the corresponding snapshot 735 may be used to restore the target version based on data of the computing object as stored at the computing system 705 (e.g., based on information included in the corresponding snapshot 735 and other information stored at the computing system 705, the computing object may be restored to its state as of the particular point in time). Additionally, or alternatively, the corresponding snapshot 735 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 735. For example, the target version of the computing object may be restored based on the information in a snapshot 735 and based on information included in a backup copy of the target object generated prior to the time corresponding to the target version. Backup copies of the computing object may be stored at the DMS 710 (e.g., in the storage nodes 785) or in some other location connected with the network 720 (e.g., in a cloud environment, which in some cases may be separate from the computing system 705).

In some examples, the DMS 710 may restore the target version of the computing object and transfer the data of the restored computing object to the computing system 705. And in some examples, the DMS 710 may transfer one or more snapshots 735 to the computing system 705, and restoration of the target version of the computing object may occur at the computing system 705 (e.g., as managed by an agent of the DMS 710, where the agent may be installed and operate at the computing system 705).

In response to a mount command (e.g., from a computing device 715 or the computing system 705), the DMS 710 may instantiate data associated with a point-in-time version of a computing object based on a snapshot 735 corresponding to the computing object (e.g., along with data included in a backup copy of the computing object) and the point-in-time. The DMS 710 may then allow the computing system 705 to read or modify the instantiated data (e.g., without transferring the instantiated data to the computing system). In some examples, the DMS 710 may instantiate (e.g., virtually mount) some or all of the data associated with the point-in-time version of the computing object for access by the computing system 705, the DMS 710, or the computing device 715.

In some examples, the DMS 710 may store different types of snapshots 735, including for the same computing object. For example, the DMS 710 may store both base snapshots 735 and incremental snapshots 735. A base snapshot 735 may represent the entirety of the state of the corresponding computing object as of a point in time corresponding to the base snapshot 735. An incremental snapshot 735 may represent the changes to the state-which may be referred to as the delta-of the corresponding computing object that have occurred between an earlier or later point in time corresponding to another snapshot 735 (e.g., another base snapshot 735 or incremental snapshot 735) of the computing object and the incremental snapshot 735. In some cases, some incremental snapshots 735 may be forward-incremental snapshots 735 and other incremental snapshots 735 may be reverse-incremental snapshots 735. To generate a full snapshot 735 of a computing object using a forward-incremental snapshot 735, the information of the forward-incremental snapshot 735 may be combined with (e.g., applied to) the information of an earlier base snapshot 735 of the computing object along with the information of any intervening forward-incremental snapshots 735, where the earlier base snapshot 735 may include a base snapshot 735 and one or more reverse-incremental or forward-incremental snapshots 735. To generate a full snapshot 735 of a computing object using a reverse-incremental snapshot 735, the information of the reverse-incremental snapshot 735 may be combined with (e.g., applied to) the information of a later base snapshot 735 of the computing object along with the information of any intervening reverse-incremental snapshots 735.

In some examples, the DMS 710 may provide a data classification service, a malware detection service, a data transfer or replication service, backup verification service, or any combination thereof, among other possible data management services for data associated with the computing system 705. For example, the DMS 710 may analyze data included in one or more computing objects of the computing system 705, metadata for one or more computing objects of the computing system 705, or any combination thereof, and based on such analysis, the DMS 710 may identify locations within the computing system 705 that include data of one or more target data types (e.g., sensitive data, such as data subject to privacy regulations or otherwise of particular interest) and output related information (e.g., for display to a user via a computing device 715). Additionally, or alternatively, the DMS 710 may detect whether aspects of the computing system 705 have been impacted by malware (e.g., ransomware). Additionally, or alternatively, the DMS 710 may relocate data or create copies of data based on using one or more snapshots 735 to restore the associated computing object within its original location or at a new location (e.g., a new location within a different computing system 705). Additionally, or alternatively, the DMS 710 may analyze backup data to ensure that the underlying data (e.g., user data or metadata) has not been corrupted. The DMS 710 may perform such data classification, malware detection, data transfer or replication, or backup verification, for example, based on data included in snapshots 735 or backup copies of the computing system 705, rather than live contents of the computing system 705, which may beneficially avoid adversely affecting (e.g., infecting, loading, etc.) the computing system 705.

In some examples, the DMS 710, and in particular the DMS manager 790, may be referred to as a control plane. The control plane may manage tasks, such as storing data management data or performing restorations, among other possible examples. The control plane may be common to multiple customers or tenants of the DMS 710. For example, the computing system 705 may be associated with a first customer or tenant of the DMS 710, and the DMS 710 may similarly provide data management services for one or more other computing systems associated with one or more additional customers or tenants. In some examples, the control plane may be configured to manage the transfer of data management data (e.g., snapshots 735 associated with the computing system 705) to a cloud environment 795 (e.g., Microsoft Azure or Amazon Web Services). In addition, or as an alternative, to being configured to manage the transfer of data management data to the cloud environment 795, the control plane may be configured to transfer metadata for the data management data to the cloud environment 795. The metadata may be configured to facilitate storage of the stored data management data, the management of the stored management data, the processing of the stored management data, the restoration of the stored data management data, and the like.

Each customer or tenant of the DMS 710 may have a private data plane, where a data plane may include a location at which customer or tenant data is stored. For example, each private data plane for each customer or tenant may include a node cluster 796 across which data (e.g., data management data, metadata for data management data, etc.) for a customer or tenant is stored. Each node cluster 796 may include a node controller 797 which manages the nodes 798 of the node cluster 796. As an example, a node cluster 796 for one tenant or customer may be hosted on Microsoft Azure, and another node cluster 796 may be hosted on Amazon Web Services. In another example, multiple separate node clusters 796 for multiple different customers or tenants may be hosted on Microsoft Azure. Separating each customer or tenant's data into separate node clusters 796 provides fault isolation for the different customers or tenants and provides security by limiting access to data for each customer or tenant.

The control plane (e.g., the DMS 710, and specifically the DMS manager 790) manages tasks, such as storing backups or snapshots 735 or performing restorations, across the multiple node clusters 796. For example, as described herein, a node cluster 796-a may be associated with the first customer or tenant associated with the computing system 705. The DMS 710 may obtain (e.g., generate or receive) and transfer the snapshots 735 associated with the computing system 705 to the node cluster 796 a in accordance with a service level agreement for the first customer or tenant associated with the computing system 705. For example, a service level agreement may define backup and recovery parameters for a customer or tenant such as snapshot generation frequency, which computing objects to backup, where to store the snapshots 735 (e.g., which private data plane), and how long to retain snapshots 735. As described herein, the control plane may provide data management services for another computing system associated with another customer or tenant. For example, the control plane may generate and transfer snapshots 735 for another computing system associated with another customer or tenant to the node cluster 796 n in accordance with the service level agreement for the other customer or tenant.

To manage tasks, such as storing backups or snapshots 735 or performing restorations, across the multiple node clusters 796, the control plane (e.g., the DMS manager 790) may communicate with the node controllers 797 for the various node clusters via the network 720. For example, the control plane may exchange communications for backup and recovery tasks with the node controllers 797 in the form of transmission control protocol (TCP) packets via the network 720.

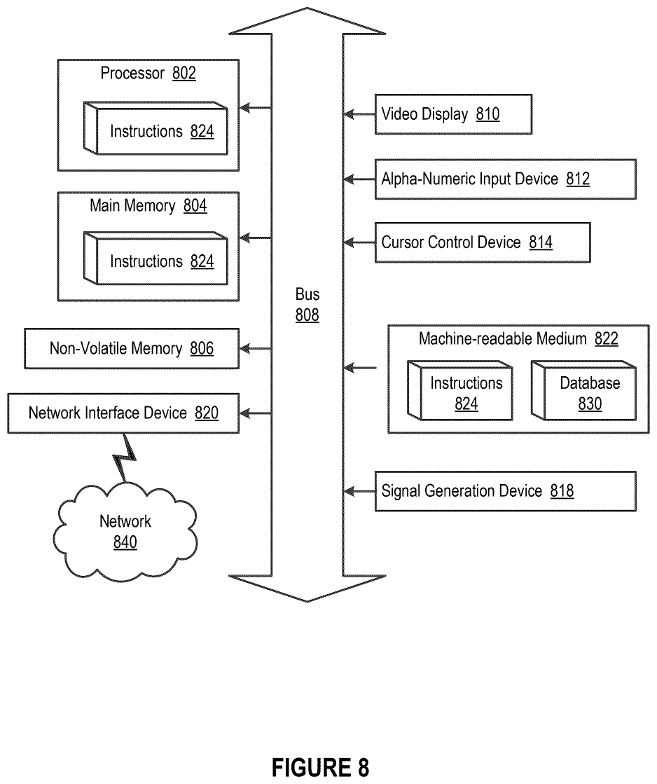

FIG. 8 illustrates an example of a computer system 800 that may be used to implement one or more of the embodiments of the present technology. For example, the computer system 800 can be implemented as a server, server system, or other type of computing system of the retrieval augmented generation (RAG) management system 102, the system, the data management service (DMS) 710, the computing system 705, the cloud environment 795, or the computing device 715. The computer system 800 can be included in a wide variety of local and remote machine and computer system architectures and in a wide variety of network and cloud computing environments that can implement the functionalities of the present technology. The computer system 800 includes sets of instructions 824 for causing the computer system 800 to perform the functionality, features, and operations discussed herein. The computer system 800 may be connected (e.g., networked) to other machines and/or computer systems. In a networked deployment, the computer system 800 may operate in the capacity of a server or a client machine in a client-server network environment, or as a peer machine in a peer-to-peer (or distributed) network environment.

The computer system 800 includes a processor 802 (e.g., a central processing unit (CPU), a graphics processing unit (GPU), or both), a main memory 804, and a nonvolatile memory 806 (e.g., volatile RAM and non-volatile RAM, respectively), which communicate with each other via a bus 808. In some embodiments, the computer system 800 can be a desktop computer, a laptop computer, personal digital assistant (PDA), or mobile phone, for example. In one embodiment, the computer system 800 also includes a video display 810, an alphanumeric input device 812 (e.g., a keyboard), a cursor control device 814 (e.g., a mouse), a signal generation device 818 (e.g., a speaker) and a network interface device 820.

In one embodiment, the video display 810 includes a touch sensitive screen for user input. In one embodiment, the touch sensitive screen is used instead of a keyboard and mouse. A machine-readable medium 822 can store one or more sets of instructions 824 (e.g., software) embodying any one or more of the methodologies, functions, or operations described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 830.

The processor 802 can be, for example, a hardware based integrated circuit (IC) or any other suitable processing device configured to run or execute a set of instructions or a set of codes. For example, the processor 802 can include a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like.

The network 840, which can represent the network 820, can be, for example, a digital telecommunication network of servers and/or computing devices. The servers and/or computing device on the network can be connected via one or more wired or wireless communication networks (not shown) to share resources such as, for example, data storage and/or computing power. The wired or wireless communication networks between servers and/or computing devices of the network can include one or more communication channels, for example, a radio frequency (RF) communication channel(s), an extremely low frequency (ELF) communication channel(s), an ultra-low frequency (ULF) communication channel(s), a low frequency (LF) communication channel(s), a medium frequency (MF) communication channel(s), an ultra-high frequency (UHF) communication channel(s), an extremely high frequency (EHF) communication channel(s), a fiber optic communication channel(s), an electronic communication channel(s), a satellite communication channel(s), and/or the like. The network can be, for example, the Internet, an intranet, a local area network (LAN), a wide area network (WAN), a metropolitan area network (MAN), a worldwide interoperability for microwave access network (WiMAX®), any other suitable communication system, and/or a combination of such networks.

The network 840 can use standard communications technologies and protocols. Thus, the network can include links using technologies such as Ethernet, 802.11, worldwide interoperability for microwave access (WiMAX®), 3G, 4G, 5G, CDMA, GSM, LTE, digital subscriber line (DSL), etc. Similarly, the networking protocols used on the network can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 806 may also be a random access memory. The non-volatile memory 806 can be a local device coupled directly to the rest of the components in the computer system 800. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 800 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in the same communication session. The routines and data can be obtained in entirety prior to the execution of the applications.

Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine or computer-readable media used to actually affect the distribution.

Some embodiments described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java™, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java™, C++, etc.) or other suitable programming languages and/or development tools. Additional examples of computer code include, but are not limited to, control signals, encrypted code, and compressed code.

For purposes of explanation, numerous specific details are set forth in order to provide a thorough understanding of the description. It will be apparent, however, to one skilled in the art that embodiments of the present technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in some embodiments,” “in various embodiments,” “in an example,” “in one implementation,” “in one instance,” “in some instances,” or the like means that a particular feature, design, structure, or characteristic described in connection with the embodiment is included in at least one embodiment of the present technology. The appearances of, for example, the phrases “according to an embodiment,” “in one embodiment,” “in an embodiment,” “in some embodiments,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the present technology of the embodiments of the invention is intended to be illustrative, but not limiting, of the scope of the invention, which is set forth in the following claims.

1. A computer-implemented method comprising:
causing, by a computing system, clustering of vectors associated with items of data, the vectors stored in a vector database, wherein the clustering is filtered by at least one selected element type comprising at least one of cells, columns, or rows used to generate the vectors;
based at least in part on the clustering, determining, by the computing system, clusters of vectors, wherein a cluster of vectors is associated with similar items of data;
based at least in part on metadata, determining types of problematic data to include redundant data and over-permissive data; and
providing, by the computing system, a navigable user interface through which references relating to objects associated with the types of problematic data are selectable, wherein selection of a reference relating to an object causes the user interface to generate detailed information about a type of problematic data associated with the object.

2. The computer-implemented method of claim 1, wherein the types of problematic data further include at least one of obsolete data, trivial data, or misplaced data.

3. The computer-implemented method of claim 1, further comprising:
converting an item of data associated with structured data or semi-structured data into a tabular structure;
based on a sketch algorithm, generating a vector associated with the item of data; and
providing the vector associated with the item of data to the vector database for storage.

4. The computer-implemented method of claim 3, wherein the generating the vector associated with the item of data is further based on a selection of rows, cells, or columns of the tabular structure as elements for the sketch algorithm.

5. The computer-implemented method of claim 4, further comprising:
based on a second selection of rows, cells, or columns of the tabular structure as elements for the sketch algorithm, generating a second vector associated with the item of data; and
providing the second vector associated with the item of data to the vector database for storage.

6. The computer-implemented method of claim 1, further comprising:
based on a sketch algorithm or a vector embedding model, generating a vector of an item of data associated with unstructured data; and
providing the vector associated with the item of data to the vector database for storage.

7. The computer-implemented method of claim 1, wherein the determining the cluster of vectors associated with the similar items of data is based on a similarity metric.

8. The computer-implemented method of claim 1, wherein
the metadata associated the similar items of data comprises at least one of creation date, owner, location, size, sensitivity, and permission set.

9. The computer-implemented method of claim 1, further comprising:
constructing a data lineage map associated with the similar items of data.

10. The computer-implemented method of claim 1, further comprising:
providing a notification to an entity associated with the similar items of data for remediation of the type of problematic data.

11. A system comprising:
at least one processor; and
a memory storing instructions that, when executed by the at least one processor, cause the system to perform operations comprising:
causing clustering of vectors associated with items of data, the vectors stored in a vector database, wherein the clustering is filtered by at least one selected element type comprising at least one of cells, columns, or rows used to generate the vectors;
based at least in part on the clustering, determining clusters of vectors, wherein a cluster of vectors is associated with similar items of data;
based at least in part on metadata, determining types of problematic data to include redundant data and over-permissive data; and
providing a navigable user interface through which references relating to objects associated with the types of problematic data are selectable, wherein selection of a reference relating to an object causes the user interface to generate detailed information about a type of problematic data associated with the object.

12. The system of claim 11, wherein the types of problematic data further include at least one of obsolete data, trivial data, or misplaced data.

13. The system of claim 11, wherein the operations further comprise:
converting an item of data associated with structured data or semi-structured data into a tabular structure;
based on a sketch algorithm, generating a vector associated with the item of data; and
providing the vector associated with the item of data to the vector database for storage.

14. The system of claim 13, wherein the generating the vector associated with the item of data is further based on a selection of rows, cells, or columns of the tabular structure as elements for the sketch algorithm.

15. The system of claim 13, wherein the operations further comprise:
based on a second selection of rows, cells, or columns of the tabular structure as elements for the sketch algorithm, generating a second vector associated with the item of data; and
providing the second vector associated with the item of data to the vector database for storage.

16. A non-transitory computer-readable storage medium including instructions that, when executed by at least on processor of a computing system, cause the computing system to perform operations comprising:
causing clustering of vectors associated with items of data, the vectors stored in a vector database, wherein the clustering is filtered by at least one selected element type comprising at least one of cells, columns, or rows used to generate the vectors;
based at least in part on the clustering, determining clusters of vectors, wherein a cluster of vectors is associated with similar items of data;
based at least in part on metadata, determining types of problematic data to include redundant data and over-permissive data; and
providing a navigable user interface through which references relating to objects associated with the types of problematic data are selectable, wherein selection of a reference relating to an object causes the user interface to generate detailed information about a type of problematic data associated with the object.

17. The non-transitory computer-readable storage medium of claim 16, wherein the types of problematic data further include at least one of obsolete data, trivial data, or misplaced data.

18. The non-transitory computer-readable storage medium of claim 16, wherein the operations further comprise:
converting an item of data associated with structured data or semi-structured data into a tabular structure;
based on a sketch algorithm, generating a vector associated with the item of data; and
providing the vector associated with the item of data to the vector database for storage.

19. The non-transitory computer-readable storage medium of claim 18, wherein the generating the vector associated with the item of data is further based on a selection of rows, cells, or columns of the tabular structure as elements for the sketch algorithm.

20. The non-transitory computer-readable storage medium of claim 18, wherein the operations further comprise:
based on a second selection of rows, cells, or columns of the tabular structure as elements for the sketch algorithm, generating a second vector associated with the item of data; and
providing the second vector associated with the item of data to the vector database for storage.
